(19) United States
(12) Patent Application Publication
(10) Pub. No.: US 2012/0176125 A1
(43) Pub. Date: Jul. 12, 2012

(54) DEVICE FOR SENSING POSITIONS OF A ROTATING WHEEL

(76) Inventors: Lan Lee, Palo Alto, CA (US); Shanshan Lee, Palo Alto, CA (US)

(21) Appl. No.: 13/005,007

(22) Filed: Jan. 12, 2011

(51) Int. Cl. G01B 7/30; H02K 7/18; G01B 11/26

(52) U.S. Cl. 324/207.25; 356/139.09; 290/1 R

(57) ABSTRACT

A device for sensing positions of a rotating wheel comprises a rotating wheel with a symmetrical weight distribution, with the rotating wheel being rigidly attached to an axle; a stationary plate coaxial with the rotating wheel, the stationary plate being free to rotate about the axle and having an asymmetrical weight distribution to keep the stationary plate stationary due to the forces of gravity; and a position sensor to sense positions of the rotating wheel.

### FIELD

This application relates generally to rotational position sensors and, more specifically, to a device including a stationary plate with an asymmetrical weight distribution having a sensor for determining the rotational positions of a wheel coaxial to the stationary plate.

### BACKGROUND

The approaches described in this section could be pursued, but are not necessarily approaches that have been previously conceived. Therefore, unless otherwise indicated herein, the approaches described in this section are not prior art to the claims in this application and are not admitted to be prior art by inclusion in this section.

Determining positions of a rotating wheel has multiple applications. For example, in a bicycle, a sensor can be attached to the front wheel fork. The fork is stationary with respect to the rotating front wheel and therefor the sensor can be easily attached directly to the fork. The sensor can include a magnet. A wire coil can be attached to the rotating wheel and as the wheel spins, electric current will be generated in the wire coil as the magnet passes by. In the case of a single magnet and wire coil combination, each generation of the electric current indicates a single rotation of the wheel. A counter can be utilized to count rotations of the wheel. By multiplying the number of the rotations by the perimeter of the wheel (which can be easily derived from its diameter), the distance traveled by the bicycle can be calculated. The relative positions of the magnet and the wire coil can be reversed. Thus, the magnet can be attached to the rotating wheel whereas the electricity-generating coil can be attached to the fork.

Furthermore, by dividing the distance traveled by the time of travel, the velocity of the bicycle can be calculated. Additionally, by calculating the rate at which the velocity increases or decreases, the rate of acceleration or deceleration can be calculated. While this technique may provide for distance, velocity, and acceleration calculations, it requires a point of reference that is stationary with respect to the rotating wheel.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are various designs of a device having a stationary plate with an asymmetrical weight distribution for sensing rotational positions of a rotating wheel coaxial to the stationary plate. In certain embodiments, the device comprises a rotating wheel with a symmetrical weight distribution, with the rotating wheel being rigidly attached to an axle; a stationary plate coaxial with the rotating wheel, with the stationary plate being free to rotate about the axle and having an asymmetrical weight distribution to keep the stationary plate stationary due to the forces of gravity; and a position sensor to sense positions of the rotating wheel with respect to the stationary plate.

In certain embodiments, the position sensor includes one or more brushes mounted on the stationary plate, with the one or more brushes intermittently contacting one or more conducting points of the rotating wheel as the rotating wheel rotates, thereby indicating the positions of the one or more conducting points of the rotating wheel with respect to the stationary plate. It will be understood that the one or more brushes on the stationary plate and the one or more contacting points of the rotating wheel are interchangeable. In certain embodiments, the rotating wheel includes one or more circuit boards, which are communicatively coupled to the one or more conducting points.

In certain embodiments, the asymmetrical weight distribution is caused by one or more extra weights attached to the stationary plate. In certain embodiments, the axle includes an electric conduit for conducting electricity between the rotating wheel and the stationary plate. In certain embodiments, the stationary plate includes a power supply. In certain embodiments, the power supply is to cause the asymmetrical weight distribution in the stationary plate.

In certain embodiments, the position sensor includes one or more wire coils and one or more magnets installed opposite each other on the rotating wheel and stationary plate, respectively. There may be more than one wire coil/magnet pair. The wire coils may be configured to generate electricity as the rotating wheel rotates and the wire coils and the magnets pass opposite each other. In certain embodiments, the magnets may be configured to cause asymmetrical weight distribution in order to keep the stationary plate substantially stationary. In certain embodiments, the wire coils may be configured to cause asymmetrical weight distribution in order to keep the stationary plate substantially stationary. In certain embodiments, the rotating wheel and the stationary plate include one or more circuit boards.

In certain embodiments, the magnets are evenly distributed over the rotating wheel to keep the weight distribution of the rotating wheel symmetrical. In certain embodiments, the wire coils are evenly distributed over the rotating wheel to keep the weight distribution of the rotating wheel symmetrical. In certain embodiments, the rotating wheel includes a solar panel configured to generate electricity. In certain embodiments, the rotating panel and the stationary panel include one or more optical sensors and optical points with the optical sensors being configured to detect one or more optical beams generated by the optical points.

### BRIEF DESCRIPTION OF DRAWINGS

Embodiments are illustrated by way of example and not limitation in the figures of the accompanying drawings, in which like references indicate similar elements and in which:

FIG. 1 is a device having a rotating wheel and a stationary plate, with the stationary plate having an extra weight configured to keep the stationary plate stationary and an electric brush configured to touch conducting points of the rotating wheel, in accordance with certain embodiments.

FIG. 2 is a device having a rotating wheel and a stationary plate, with the stationary plate having an extra weight configured to keep the stationary plate stationary and a plurality of electric brushes configured to touch conducting points of the rotating wheel, in accordance with certain embodiments.

FIG. 3 is a device having a rotating wheel, a stationary plate with one or more batteries mounted on the stationary plate as extra weights to keep the stationary plate stationary, and a plurality of electric brushes configured to touch conducting points and a conducting ring of the rotating wheel, in accordance with certain embodiments.

FIG. 4 is a device having a rotating wheel and a stationary plate, with the stationary plate having a wire coil to keep the stationary plate stationary and the rotating wheel having a plurality of magnets, in accordance with certain embodiments.

FIG. 5 is a device having a rotating wheel and a stationary plate, with the stationary plate having a magnet to keep the stationary plate stationary and the rotating wheel having a plurality of wire coils, in accordance with certain embodiments.

FIG. 6 is a device having a rotating wheel and a stationary plate, with the stationary plate having a plurality of wire coils to keep the stationary plate stationary and the rotating wheel having a plurality of magnets, in accordance with certain embodiments.

FIG. 7 is a device having a rotating wheel and a stationary plate, with the stationary plate having an extra weight to keep the stationary plate stationary and the rotating wheel including a solar panel, in accordance with certain embodiments.

FIG. 8 is a device having a rotating wheel and a stationary plate, with the stationary plate having an extra weight to keep the stationary plate stationary and the rotating wheel having an optical sensor, in accordance with certain embodiments.

### DETAILED DESCRIPTION

In certain example embodiments, a device having a stationary plate with an asymmetrical weight distribution for sensing rotational positions of a rotating wheel coaxial to the stationary plate is described. Configuring the stationary plate to include an extra weight for the asymmetrical weight distribution may allow the creation of stationary reference points without a need for an external object such as, for example, a front wheel fork of a bicycle. As the rotating wheel rotates, various techniques may be utilized to detect rotations. For example, a wire coil and a magnet may be installed opposite each other on the rotating wheel and the stationary plate to generate electricity in the wire coil on every revolution of the moving wheel. In other embodiments, a battery and/or a solar panel may be utilized to generate electricity, which can used for detecting rotations by having one or more electricity conducting brushes installed on the stationary plate to close the circuit by brushing over conducting points of the moving wheel. In the case of the solar panel, sunlight is needed; however, a battery may be installed to accumulate electricity during the day, thereby allowing later use of the stored energy.

In contrast to the existing solutions, the system described herein allows determining relative positions of a moving wheel without having an external reference point, as the stationary plate coaxial with the moving wheel creates the reference point. The system can be utilized in certain applications where there are no external reference objects.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In certain example embodiments, a device having a stationary plate with an asymmetrical weight distribution for sensing rotational positions of a rotating wheel coaxial to the stationary plate may include a rotating wheel coupled to an axle. A weight may be attached to the bottom of the stationary plate so that a wire can be connected to the weight. The stationary plate and the attached wire are kept stationary by the forces of gravity while the rotating wheel rotates. The wire may be attached to various circuitries and brush over conducting points of the rotating wheel. It will be understood that the brush on the stationary plate and the contacting point of the rotating wheel are interchangeable. Thus the brush may be utilized as a conducting point on the stationary plate and the conducting point may be utilized as a brush on the rotating wheel. The rotating wheel may spin to a particular position and that position may be determined from a particular conducting point. For example, one conducting point may designate a 0-degree change from a reference position, the next conducting point may designate a 30, 60, 90, or 120-degree change from the reference point, and so forth until a 360/0 degree change is reached. Because the weight stays at the bottom of the stationary plate, the exact position of the moving wheel can be determined.

The conducting points of the moving wheel may be raised to allow the one or more wires/brushes extended out of the weight of the stationary plate to contact the conducting points and to close an electric circuit. By knowing the reference point and counting the number of touches between the wire/brush and conducting points, the position of the wheel can be determined. Accordingly, distance traveled by the rotating wheel, its velocity, and acceleration can be calculated.

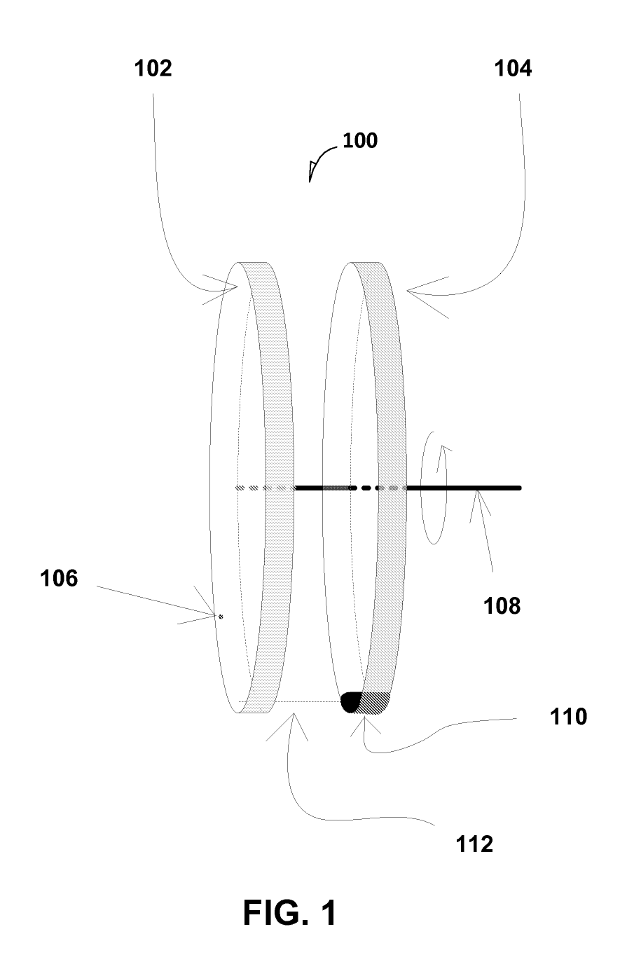

FIG. 1 shows a device 100 having a rotating wheel 102 and a stationary plate 104. The stationary plate is shown to include an extra weight 110 to keep the stationary plate stationary and an electric brush 112 to touch conducting point 106 of the rotating wheel 102. It will be understood that the electric brush 112 on the stationary plate 104 and the contacting point 106 of the rotating wheel 102 are interchangeable. Thus the brush may be utilized as a conducting point on the stationary plate and the conducting point may be utilized as a brush on the rotating wheel. The device 100 is shown to also include an axle 108. The rotating wheel 102 is rigidly attached to and rotates with the axle 108, while the stationary plate 104 is free to rotate about the axle 108. The rotating wheel 102, in some example embodiments, may include a circuit board. The stationary plate 104 and/or the rotating wheel 102 may or may not include power supplies. The conducting point 106 may be located on the rotating wheel 102. The rotating wheel 102 and the stationary plate 104 are coaxial with respect to each other because they share the common axle 108. The stationary plate 104 may include the extra weight 110 at its bottom, so as the axle 108 rotates, the stationary plate 104 is kept from rotating by the weight of the extra weight 110. In contrast, the rotating wheel 102 is rigidly attached to the axle 108 and therefore rotates together with the axle 108.

An external power supply may be utilized to supply negative and/or positive charges to the conduit axle 108. The electric brush 112 may extend from the extra weight 110 and keep brushing the rotating wheel 102 as the rotating wheel 102 rotates intermittently, thereby coming into contact with the conducting point 106. The conducting point 106 may be supplied with an electric current via the conduit axle 108 and the rotating wheel 102. Therefore, as the electric brush 112 touches the power point 106, the electric circuit closes. It will be understood that the circuit board may be located in its entirety or in part at the rotating wheel 102, the stationary plate 104, and/or distributed among both the rotating wheel 102 and the stationary plate 104. A counter may be utilized to keep a count of events that trigger closure of the circuitry.

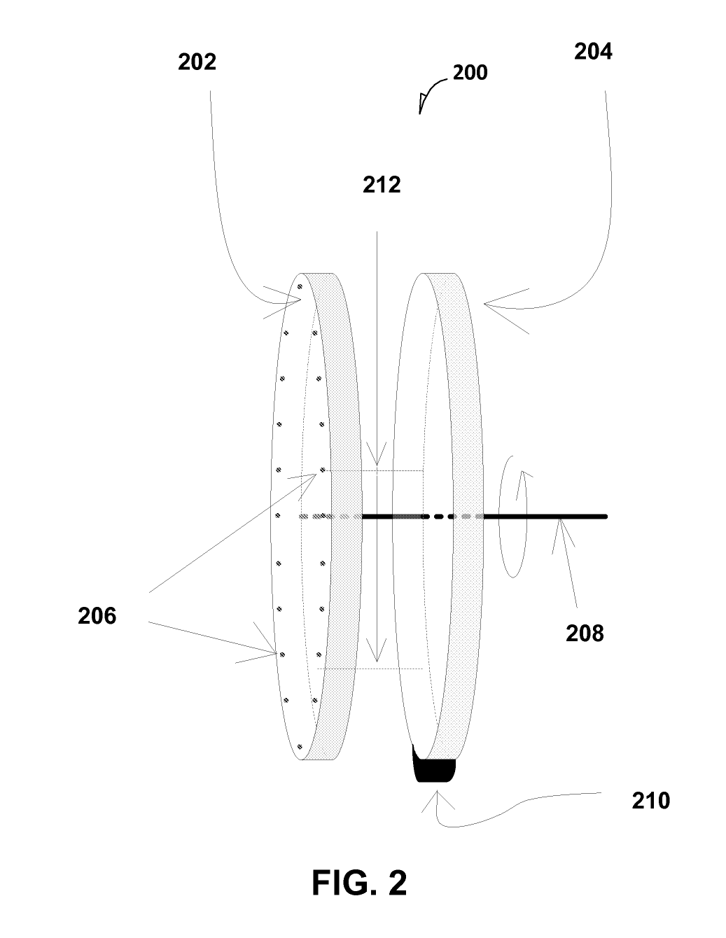

FIG. 2 shows a device 200 having a rotating wheel 202 and a stationary plate 204, with the stationary plate 204 having an extra weight 210 to keep it stationary and a plurality of electric brushes 212 to touch a plurality of conducting points 206 of the rotating wheel 202. It will be understood that the electric brushes 212 on the stationary plate 204 and the contacting points 206 of the rotating wheel 202 are interchangeable. Thus the electric brushes 212 may be utilized as the conducting points 206 on the stationary plate 204 and the conducting points 206 may be utilized as the electric brushes 212 on the rotating wheel 202. The device 200 is shown to also include an axle 208. The device 200 is similar to the device 100 described above with reference to the FIG. 1. However, the device 200 is configured to include a plurality of electric brushes 212. This configuration allows for having a plurality of circuitries connected to the plurality of conducting points 206. Therefore, for each electric brush 212 touching a conducting point 206, a separate event can be triggered. Additionally, the current supplied to the conducting points 206 and/or electric brushes 212 can be switched between positive and negative. Therefore, each connection between an electric brush 212 and a conducting point 206 may be utilized to execute a separate predetermined logical event.

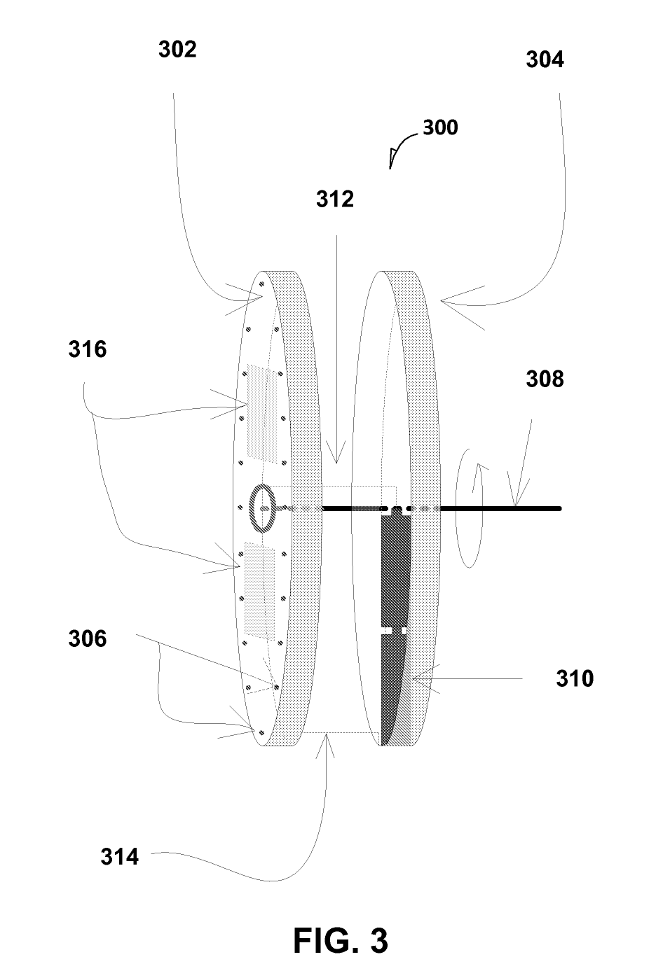

FIG. 3 shows a device 300 having a rotating wheel 302 and a stationary plate 304. The stationary plate 304 may include one or more batteries 310 as extra weights to keep the stationary plate 304 stationary. The stationary plate 304 may also include a plurality of electric brushes 314 to touch conducting points 306 of the rotating wheel 302 as the rotating wheel 302 rotates. The device 300 utilizes the batteries 310 as an extra weight to keep the stationary plate 304 stationary. Instead of the rotating wheel 302 being a circuit board as in the above-mentioned embodiments, the device 300 includes one or more of separate circuit boards 316. The electric brush 312 may be supplied with electric current directly from the batteries 310, thereby obviating the need for an external power supply supplying electric current via the axle 308.

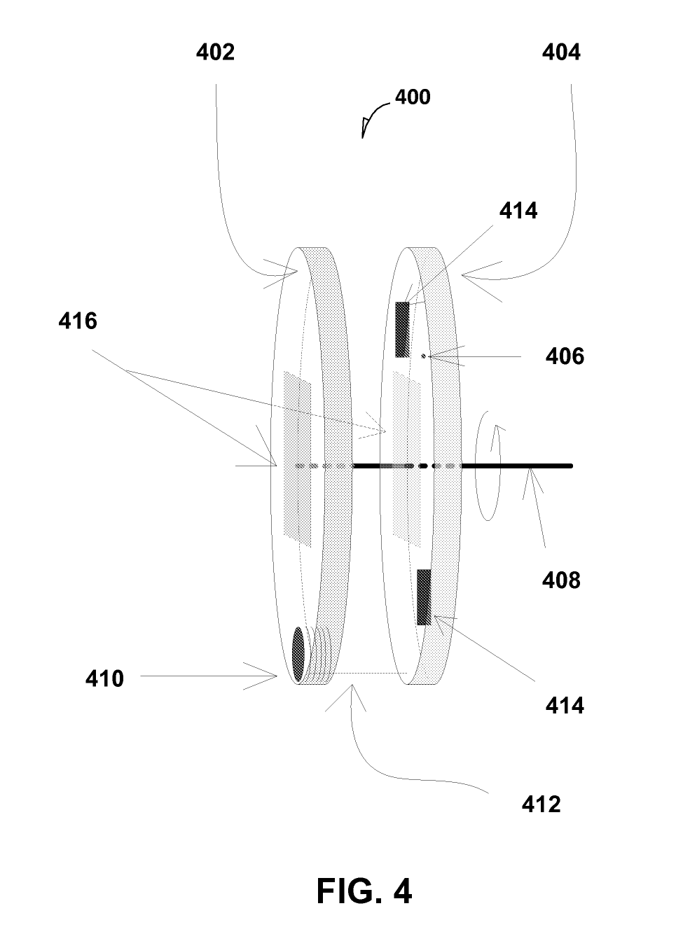

FIG. 4 shows a device 400 having a rotating wheel 404 and a stationary plate 402. The stationary plate 402 may include a wire coil 410 to keep the stationary plate 402 stationary, and the rotating wheel 404 includes a plurality of magnets 414. The wire coil 410 and the plurality of magnets 414 may be installed opposite each other on the rotating wheel 404 and stationary plate 402, respectively. The wire coil 410 may be configured to generate electricity as the rotating wheel 404 rotates, and the wire coil 410 and the plurality of magnets 414 pass opposite each other. The wire coil 410 may be configured to cause the asymmetrical weight distribution in the stationary plate 402 so that the stationary plate 402 stays substantially stationary. The device 400 may include a plurality of circuit boards 416 distributed over the rotating wheel 404 and the stationary plate 402. The circuit boards 416 may be connected to the conducting point 406. It will be understood that the electric brush 412 on the stationary plate 402 and the contacting point 406 of the rotating wheel 404 are interchangeable. Thus, the electric brush 412 may be utilized as the conducting point 406 on the stationary plate 402 and the conducting point 406 may be utilized as the electric brush 412 on the rotating wheel 404.

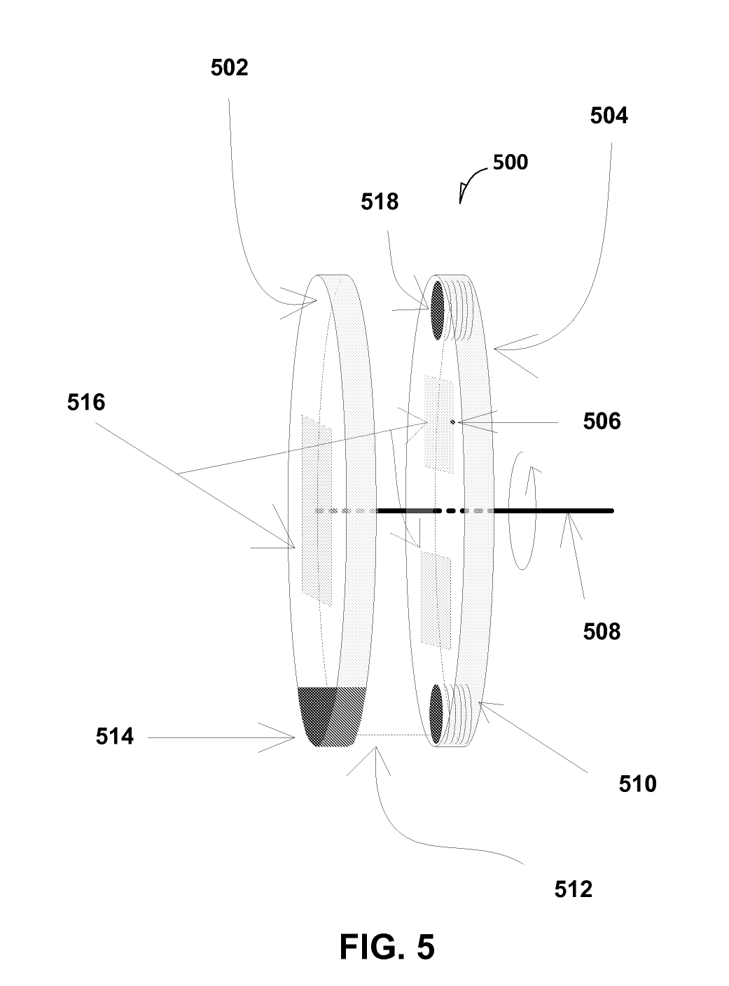

FIG. 5 shows a device 500 having a rotating wheel 504 and a stationary plate 502. The stationary plate 502 includes a magnet 514 to keep the stationary plate 502 substantially stationary, and the rotating wheel 504 includes a plurality of wire coils 510 and 518. Instead of having the wire coils 510 and 518 serve as an extra weight as described with reference to FIG. 4 above, the magnet 514 serves as the extra weight keeping the stationary plate 502 substantially stationary. As the rotating wheel 504 rotates, electric current is generated in the wire coils 510 and 518.

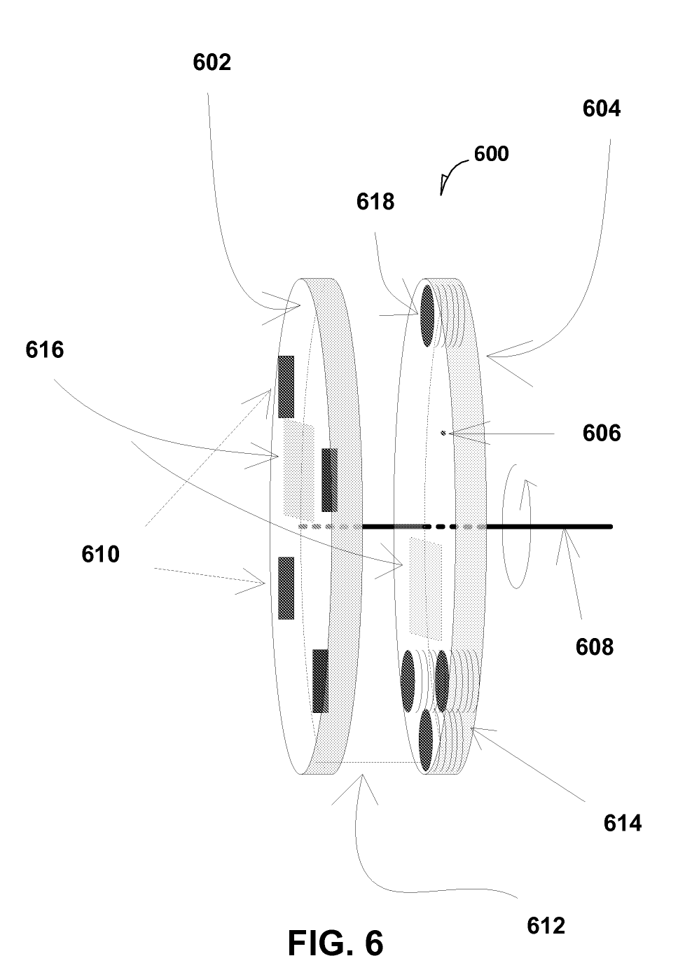

FIG. 6 shows a device 600 having a rotating wheel 602 and a stationary plate 604. The stationary plate 604 may include a plurality of wire coils 614 and 618 placed asymmetrically to keep the stationary plate 604 stationary. The rotating wheel 602 may include a plurality of magnets 610. This design is another embodiment where magnets are spread over the different locations of the rotating wheel 602.

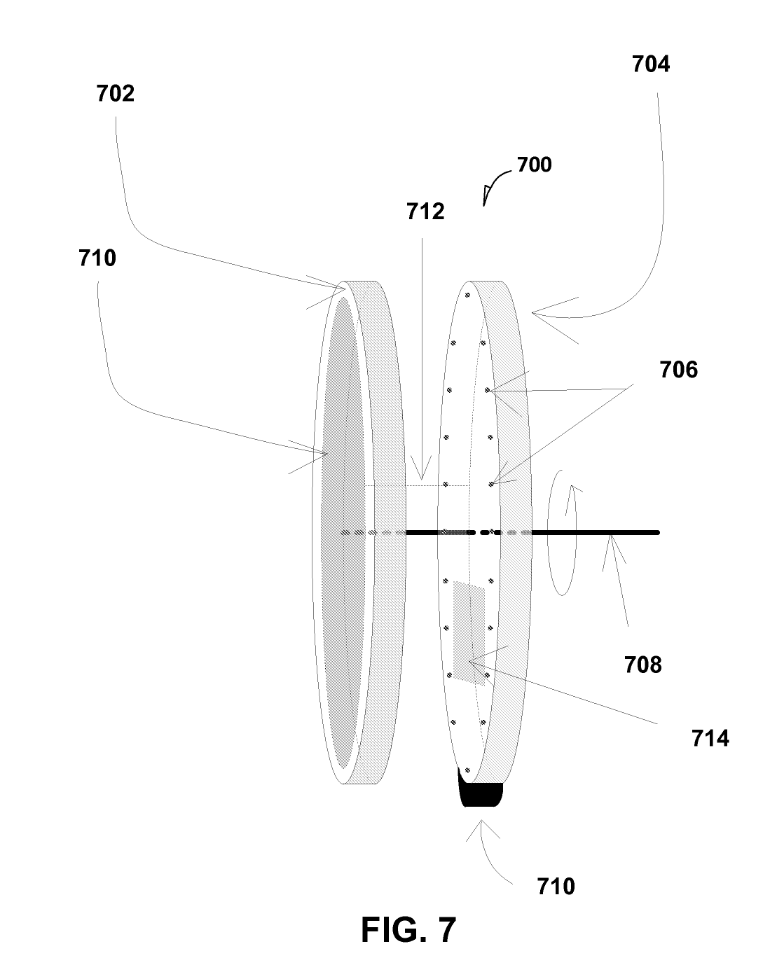

FIG. 7 shows a device 700 having a rotating wheel 702 and a stationary plate 704. The stationary plate 704 includes an extra weight 710 to keep the stationary plate 704 stationary. The rotating wheel 702 may include a solar panel 710 to generate an electric current. The electric current generated by the solar panel 710 may be utilized to power various circuits connected to the connecting points 706. It will be understood that the electric brush 712 on the rotating wheel 702 and the contacting points 706 of the stationary plate 704 are interchangeable. Thus, the electric brush 712 may be utilized as the conducting point 706 on the rotating wheel 702 and the conducting points 706 may be utilized as the electric brush 712 on the stationary plate 704.

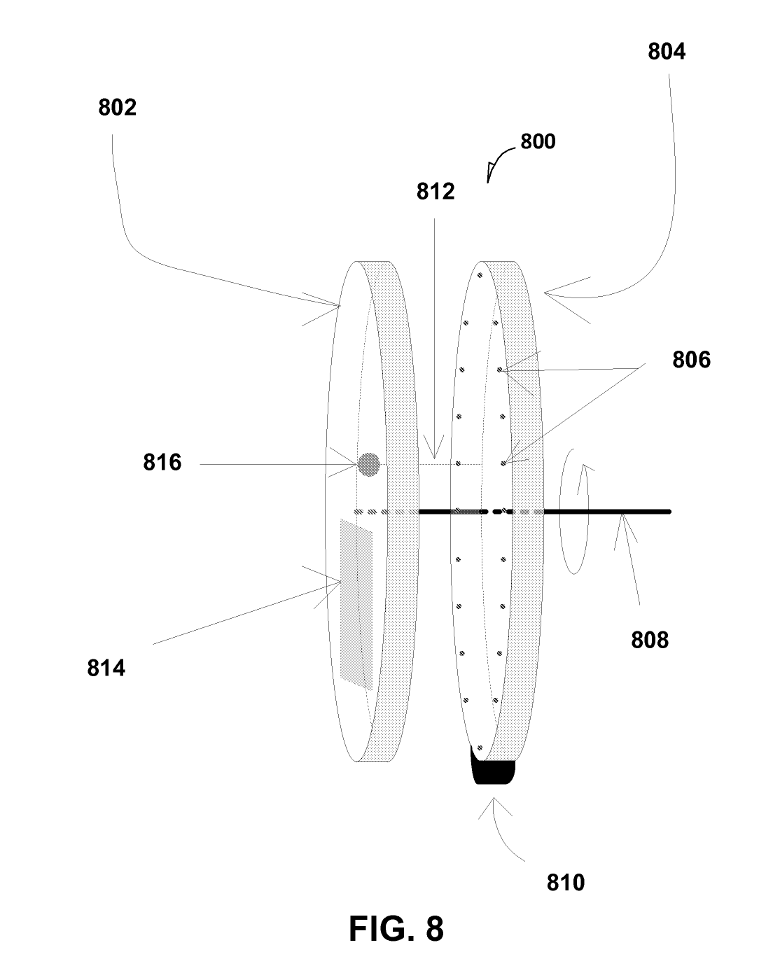

FIG. 8 shows a device 800 having a rotating wheel 802 and a stationary plate 804. The stationary plate 804 may include an extra weight 810 to keep the stationary plate 804 substantially stationary and the rotating wheel 802 may include an optical sensor 816. With a compact disk (CD) type of sensor, the device 800 may have an optical sensor 816 aim an optical beam 812 at the stationary plate 804. An optical point 806 may reflect the beam back at the optical sensor 816 so that the position of the rotating wheel 802 may be determined. It will be understood that the optical sensor 816 on the rotating wheel 802 and the optical points 806 on the stationary plate 804 are interchangeable. Thus the optical sensor 816 may be utilized as the optical points 806 and the optical points 806 may be utilized as the optical sensor 816.

Thus, a device for sensing positions of a rotating wheel has been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What I claim is:

1. A device for sensing rotational positions of a rotating wheel, the device comprising:
a rotating wheel with a symmetrical weight distribution, the rotating wheel being rigidly attached to an axle;
a stationary plate coaxial with the rotating wheel, the stationary plate being free to rotate about the axle and configured to include an asymmetrical weight distribution to keep the stationary plate stationary due to forces of gravity; and
a position sensor configured to sense positions of the rotating wheel with respect to the stationary plate.

2. The device of claim 1, wherein the position sensor includes one or more brushes mounted on the stationary plate or the rotating plate, the one or more brushes configured to intermittently contact one or more conducting points of the rotating wheel or the stationary plate as the rotating wheel rotates, thereby indicating positions of the one or more conducting points of the rotating wheel.

3. The device of claim 2, wherein the rotating wheel is configured to include one or more circuit boards, the one or more circuit boards being communicatively coupled to the one or more conducting points or one or more electric brushes.

4. The device of claim 1, wherein the asymmetrical weight distribution is caused by one or more extra weights attached to the stationary plate.

5. The device of claim 1, wherein the axle includes an electric conduit configured to conduct electricity between the rotating wheel and the stationary plate.

6. The device of claim 1, wherein the stationary plate includes a power supply.

7. The device of claim 6, wherein the power supply is configured to cause the asymmetrical weight distribution.

8. The device of claim 1, wherein the position sensor includes one or more wire coils and one or more magnets installed opposite each other on the rotating wheel and stationary plate, respectively, with the wire coils being configured to generate electricity as the rotating wheel rotates and the one or more wire coils and the one or more magnets pass opposite each other.

9. The device of claim 8, wherein the one or more magnets are configured to provide a weight in order to keep the stationary plate substantially stationary.

10. The device of claim 8, wherein the one or more wire coils are configured to provide a weight in order to keep the stationary plate substantially stationary.

11. The device of claim 8, wherein the rotating wheel and the stationary plate include one or more circuit boards.

12. The device of claim 8, wherein the one or more magnets are evenly distributed over the rotating wheel to keep the weight distribution of the rotating wheel symmetrical with respect to the center of the rotating wheel.

13. The device of claim 8, wherein the one or more wire coils are evenly distributed over the rotating wheel to keep the weight distribution of the rotating wheel symmetrical with respect to the center of the rotating wheel.

14. The device of claim 1, wherein the rotating wheel includes a solar panel, the solar panel being configured to generate electricity.

15. The device of claim 1, wherein the rotating panel and the stationary panel include one or more optical sensors and one or more optical points, the optical sensors being configured to detect one or more optical beams generated by the one or more optical points.
